(19) United States
(12) Patent Application Publication
(10) Pub. No.: US 2021/0253850 A1
(43) Pub. Date: Aug. 19, 2021

(54) THERMOPLASTIC COMPOSITIONS HAVING GOOD MECHANICAL PROPERTIES

(71) Applicant: Covestro Deutschland AG, Leverkusen (DE)

(72) Inventor: Derk Erich Wandner, Odenthal (DE)

(21) Appl. No.: 16/465,867

(22) PCT Filed: Dec. 18, 2017
(86) PCT No.: PCT/EP2017/083366

§ 371 Date: Jul. 10, 2019

(30) Foreign Application Priority Data
Dec. 19, 2016 (EP) 16204954.8

(51) Int. Cl. C08L 69/00

(52) U.S. Cl. CPC C08L 69/00

(57) ABSTRACT

The invention relates to compositions for the production of thermoplastic moulding materials, where the compositions comprise the following constituents:
A) at least one polymer selected from the group consisting of aromatic polycarbonate, aromatic polyester carbonate and polyester,
B) at least one anhydride-functionalized with ethylene-α-olefin-copolymer or ethylene-α-olefin terpolymer,
where the weight-average molar mass of component B, determined by high-temperature gel permeation chromatography using ortho-dichlorobenzene as solvent against polystyrene standards is from 50000 to 500000 g/mol,
and also to a process for the production of the moulding materials, to the moulding materials themselves, to the use of the compositions or moulding materials for the production of mouldings, and to the mouldings themselves.

### CROSS-REFERENCE TO RELATED APPLICATIONS

This application is a U.S. national stage application, filed under 35 U.S.C. § 371, of International Application No. PCT/EP2017/083366, which was filed on Dec. 18, 2017, and which claims priority to European Patent Application No. 16204954.8, which was filed on Dec. 19, 2016.

The contents of each are incorporated by reference into this specification.

### FIELD

The present invention relates to thermoplastic compositions for the production of thermoplastic moulding materials, to a process for the production of thermoplastic moulding materials, to the moulding materials themselves, to the use of the compositions or moulding materials for the production of mouldings, and to the mouldings themselves.

The invention in particular relates to thermoplastic polycarbonate compositions.

### BACKGROUND

Polycarbonate compositions have been known for a long time, and these materials are used to produce mouldings for a wide variety of applications, for example in the automobile sector, for rail vehicles, for the construction sector, in the electrical/electronics sector and in domestic appliances. The quantity and nature of the constituents in the formulation can be varied to achieve a wide range of modification of the compositions, and thus also of the resultant mouldings, so that the thermal, rheological and mechanical properties of these are appropriate to the requirements of each application.

Polycarbonate per se features very good heat resistance and high toughness at room temperature. In order to improve toughness at low temperatures, polycarbonate is often blended with polymers having low glass transition temperatures as elastic component.

Examples of these impact modifiers used are graft polymers with core-shell structure made of a butadiene-containing core and of a graft shell made of vinyl(co)polymer, this shell being intended to ensure (a degree of) compatibility of the modifier with the polycarbonate and with other polymer components that may be present in the mixture.

EP 0 315 868 A2 describes the use of graft polymers produced from a particulate diene rubber and a graft shell made of vinyl monomers in polycarbonate compositions. The moulding materials feature good toughness at low temperatures and good resistance to petroleum spirit.

WO 2013/045544 A1 discloses flame-retardant PC/ABS compositions with good impact resistance, flowability and chemicals resistance. The compositions comprise polycarbonates, graft polymers and a rubber-free alpha-olefin terpolymer. The moulding materials are suitable in particular for thin-walled housing parts in the electrical and electronics sector.

US 2015/0353732 A1 discloses compositions comprising polycarbonate and/or polyester, optionally impact modifier and flame retardant, and also a compatibilizer with a maleic-anhydride-functionalized polyolefin. Improved impact resistance is achieved by virtue of the compatibilizer.

WO 2013/045552 A1 discloses thermoplastic moulding materials made of polycarbonate and of inorganic fillers, comprising from 0.01 to 0.5 part by weight of at least one anhydride-modified alpha-olefin terpolymer and having a high level of stiffness and good toughness.

US 2014/0329948 A1 discloses impact-modified and glass-fibre-reinforced polycarbonate compositions with high stiffness and good thermal and rheological properties in conjunction with good flame retardancy. The compositions comprise polycarbonate, flame retardant, glass fibres and an anhydride-modified alpha-olefin terpolymer.

WO 2015/189761 discloses thermally conductive thermoplastic compositions comprising a polymer matrix, a chemically reactive impact modifier and a thermally conductive filler. A maleic-anhydride-grafted ethylene copolymer is disclosed as chemically reactive impact modifier. The compositions feature good thermal conductivity and toughness.

The compositions described in the prior art feature either good toughness or good processability. An additional restriction exists in the chemical resistance of polycarbonate and of impact-modified polycarbonate in relation to various chemicals and preparations of chemicals, for example creams. Formulations with good melt flowability in particular exhibit even greater sensitivity to various chemicals. However, for many applications it is advantageous to provide moulding materials with low-temperature toughness, good melt flowability, and relatively high resistance to chemicals and preparations of chemicals, for example for thin-wall applications or complex component geometries.

### SUMMARY

It was therefore desirable to provide compositions which have good processing properties deriving from good melt flowability, and which also at the same time permit production of mouldings with good toughness extending to low temperatures. The compositions should also feature significantly increased resistance to various media, and also high heat resistance.

Surprisingly, it has now been found that compositions for the production of thermoplastic moulding materials, where the compositions comprise the following constituents:
A) At least one polymer selected from the group consisting of aromatic polycarbonate, aromatic polyester carbonate or polyester,
B) at least one anhydride-functionalized ethylene-α-olefin copolymer or ethylene-α-olefin terpolymer,
where the weight-average molar mass Mw of component B is from 50000 to 500000 g/mol, preferably from 10000 to 400000 g/mol, particularly preferably from 150000 to 350000 g/mol,
exhibit the advantageous properties.

### DETAILED DESCRIPTION

The compositions preferably comprise
from 40 to 99.9% by weight, more preferably from 60 to 99.4% by weight, particularly preferably from 80 to 98.8% by weight, of component A,
from 0.1 to 10% by weight, more preferably from 0.5 to 9% by weight, particularly preferably from 1 to 8% by weight, of component B,
from 0 to 50% by weight, more preferably from 0.1 to 39.5% by weight, particularly preferably from 0.2 to 19% by weight, of other polymer constituents and/or polymer additives as component C.

In a preferred embodiment, the compositions consist of at least 90% by weight of components A to C. The compositions most preferably consist only of components A to C.

Component B can take the form of physical mixture component in the composition.

It is also possible that the anhydride groups of component B enter into chemical reactions with polycarbonate (component A) and/or with other components of the composition.

The anhydride groups can also enter into chemical reactions with moisture or with other impurities.

These reactions occur in particular in the melt at high temperatures of the type prevailing during compounding of the melt (e.g. in an extruder) and during processing by injection moulding.

Anhydride group content is thus reduced. Moulding materials considered to be inventive for the purposes of the present Patent Application include those obtained when components A, B and optionally C are physically mixed and subjected to compounding in the melt.

It is also possible here that some of the components of the composition are not metered simultaneously into the compounding assembly; it is also possible by way of example that a portion is metered into the system by way of other metering equipment, for example an ancillary extruder.

### Component A

Polycarbonates for the purposes of the present invention are either homopolycarbonates or copolycarbonates and/or polyester carbonates; the polycarbonates can, as is known, be linear or branched. It is also possible according to the invention to use mixtures of polycarbonates.

The weight-average molar masses M_{w} of the thermoplastic polycarbonates, inclusive of the thermoplastic, aromatic polyester carbonates, determined by GPC (gel permeation chromatography in methylene chloride with polycarbonate as standard), is from 15000 g/mol to 50000 g/mol, preferably from 18000 g/mol to 35000 g/mol, more preferably from 20000 g/mol to 32000 g/mol, particularly preferably from 23000 g/mol to 31000 g/mol, very particularly preferably from 24000 g/mol to 31000 g/mol.

A portion, up to 80 mol %, preferably from 20 mol % to 50 mol %, of the carbonate groups in the polycarbonates used according to the invention can have been replaced by aromatic dicarboxylic ester groups. The term aromatic polyester carbonates is used for polycarbonates of this type comprising not only acid moieties derived from carbonic acid but also acid moieties of aromatic dicarboxylic acids incorporated into the molecular chain For the purposes of the present invention, they are subsumed within the generic term thermoplastic aromatic polycarbonates.

The polycarbonates are produced in a known manner from diphenols, carbonic acid derivatives, optionally chain terminators and optionally branching agents, but for the production of the polyester carbonates a portion of the carbonic acid derivatives are replaced by aromatic dicarboxylic acids or derivatives thereof in accordance with the extent to which the carbonate structural units are to be replaced by aromatic dicarboxylic ester structural units in the aromatic polycarbonates.

Dihydroxyaryl compounds suitable for the production of polycarbonates are those of the formula (1)

HO—Z—OH (1),

in which
Z is an aromatic moiety having from 6 to 30 C atoms and can comprise one or more aromatic rings, can have substitution, and can comprise aliphatic or cycloaliphatic moieties or alkylaryl moieties or heteroatoms as bridging elements.
Z in formula (1) is preferably a moiety of the formula (2)

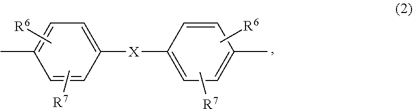

in which
R⁶ and R⁷ are mutually independently H, C₁- to C₁₈-alkyl-, C₁- to C₁₈-alkoxy, halogen such as Cl or Br or respectively optionally substituted aryl or aralkyl, preferably H or C₁- to C₁₂-alkyl, particularly preferably H or C₁- to C₈-alkyl and very particularly preferably H or methyl, and
X is a single bond, —SO₂—, —CO—, —O—, —S—, C₁- to C₆-alkylene, C₂- to C₅-alkylidene or C₅- to C₆-cycloalkylidene which may have substitution by C₁- to C₆-alkyl, preferably methyl or ethyl, or else is C₆- to C₁₂-arylene, optionally fused to other aromatic rings comprising heteroatoms.

X is preferably a single bond, C₁- to C₅-alkylene, C₂- to C₅-alkylidene, C₅- to C₆-cycloalkylidene, —O—, —SO—, —CO—, —S—, —SO₂—.
or is a moiety of the formula (2a)

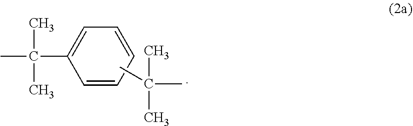

Examples of dihydroxyaryl compounds (diphenols) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulphides, bis(hydroxyphenyl) sulphones, bis(hydroxyphenyl) sulphoxides, 1,1′-bis(hydroxyphenyl)diisopropylbenzenes and ring-alkylated and ring-halogenated compounds derived therefrom.

Examples of diphenols suitable for the production of the polycarbonates to be used according to the invention are hydroquinone, resorcinol, dihydroxydiphenyl, bis(hydroxyphenyl)alkanes, bis(hydroxyphenyl)cycloalkanes, bis(hydroxyphenyl) sulphides, bis(hydroxyphenyl) ethers, bis(hydroxyphenyl) ketones, bis(hydroxyphenyl) sulphones, bis(hydroxyphenyl) sulphoxides, α,α′-bis(hydroxyphenyl)diisopropylbenzenes and alkylated, ring-alkylated and ring-halogenated compounds derived therefrom.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 1,3-bis [2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxydiphenyl, 1,1-bis(4-hydroxyphenyl)phenylethane, 2,2-bis(4-hydroxyphenyl)propane (bisphenol A), 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC). 2,2-Bis(4-hydroxyphenyl)propane (bisphenol A) is in particular preferred.

These and other suitable diphenols are described by way of example in U.S. Pat. Nos. 2,999,835 A, 3,148,172 A, 2,991,273 A, 3,271,367 A, 4,982,014 A and 2,999,846 A, in German laid-open specifications 1 570 703 A, 2 063 050 A, 2 036 052 A, 2 211 956 A and 3 832 396 A, in the French patent specification 1 561 518 Al, in the monograph by H. Schnell, “Chemistry and Physics of Polycarbonates”, Interscience Publishers, New York 1964, pp. 28ff and pp. 102ff, and in D. G. Legrand, J. T. Bendler, “Handbook of Polycarbonate Science and Technology”, Marcel Dekker, New York, 2000, pp. 72ff.

In the case of the homopolycarbonates, only one diphenol is used; in the case of copolycarbonates, two or more diphenols are used. The diphenols used, and also all of the other chemicals and auxiliaries added to the synthesis, can comprise contamination from the impurities arising during the synthesis, handling and storage of the same. However, it is desirable to use raw materials of the highest possible purity.

The monofunctional chain terminators required for molecular-weight regulation, for example phenols or alkylphenols, in particular phenol, p-tert-butylphenol, isooctylphenol, cumylphenol, chloroformic esters of these, or acyl chlorides of monocarboxylic acids, or mixtures of these chain terminators, are either introduced with the bisphenolate(s) into the reaction or else are added to the synthesis at any desired juncture while phosgene or terminal chloroformic acid groups are still present in the reaction mixture or, in the case of the acyl chlorides and chloroformic esters as chain terminators, as long as a sufficient quantity of terminal phenolic groups of the resulting polymer is available. However, it is preferable that the chain terminator(s) is/are added after the phosgenation procedure at a location/juncture at which phosgene is no longer present but the catalyst has not yet been metered into the system, or that they are metered into the system before the catalyst or in parallel or together with the catalyst.

Any branching agents or branching agent mixtures to be used are added to the synthesis in the same manner, but usually before the chain terminators. Compounds usually used are trisphenols, quaterphenols or acyl chlorides of tri- or tetracarboxylic acids, or else mixtures of the polyphenols or of the acyl chlorides.

Examples of some of the compounds that can be used as branching agents having three, or more than three, phenolic hydroxy groups are phloroglucinol, 4,6-dimethyl-2,4,6-tri(4-hydroxyphenyl)hept-2-ene, 4,6-dimethyl-2,4,6-tri-(4-hydroxyphenyl)heptane, 1,3,5 -tris(4-hydroxyphenyl)benzene, 1,1,1-tri-(4-hydroxyphenyl)ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuryl chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The quantity of the branching agents optionally to be used is from 0.05 mol % to 2 mol %, again based on moles of diphenols respectively used.

The branching agents can either be initially charged together with the diphenols and the chain terminators in the aqueous alkaline phase or added in solution in an organic solvent before the phosgenation procedure.

All of these measures for production of the polycarbonates are familiar to those skilled in the art.

Examples of suitable aromatic dicarboxylic acids for the production of the polyester carbonates are orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulphone dicarboxylic acid, 2,2-bis(4-carboxyphenyl)propane, trimethyl-3-phenylindane-4,5′-dicarboxylic acid.

Particular preference is given to use of terephthalic acid and/or isophthalic acid among the aromatic dicarboxylic acids.

Derivatives of the dicarboxylic acids are the diacyl dihalides and the dialkyl dicarboxylates, in particular the diacyl dichlorides and the dimethyl dicarbonates.

Replacement of the carbonate groups by the aromatic dicarboxylic ester groups is in essence stoichiometric, and also quantitative, and the molar ratio of the reactants is therefore also maintained in the finished polyester carbonate. The aromatic dicarboxylic ester groups can be incorporated either randomly or blockwise.

Preferred modes of production of the polycarbonates to be used according to the invention, inclusive of the polyester carbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

In the first case the acid derivatives used are preferably phosgene and optionally diacyl dichlorides; in the latter case they are preferably diphenyl carbonate and optionally dicarboxylic diesters. Catalysts, solvents, work-up, reaction conditions, etc. have been sufficiently well described and are known both for the production of poly carbonate and for the production of polyester carbonate.

In a preferred embodiment, component A used comprises only aromatic polycarbonate, most preferably an aromatic polycarbonate with bisphenol A as diphenol unit.

### Component B

Component B used comprises ethylene-α-olefin copolymers or terpolymers with grafted-on anhydride groups. For the purposes of this patent application, component B is also referred to as ethylene-α-olefin copolymer or terpolymer functionalized with anhydride groups.

The anhydride is preferably selected from the group comprising maleic anhydride, phthalic anhydride, fumaric anhydride and itaconic anhydride, and also mixtures of these. Maleic anhydride is particularly preferred as anhydride.

The copolymers or terpolymers preferably comprise, as comonomer (α-olefin) alongside ethylene, 1-propene, 1-butene, 1-isobutene, 1-pentene, 1-hexene, 1-heptene, 1-octene, 1-nonene, 1-decene, 1-undecene, 1-dodecene, 1-tridecene, 1-tetradecene, 1-octadecene, 1-nonadecene, and also mixtures of these.

In particular, a copolymer of ethylene and 1-octene is used.

The olefinic copolymers can be produced as described in U.S. Pat. Nos. 5,272,236 A and 5,278,272 A. Grafting with anhydride groups is described by way of example in U.S. Pat. No. 323,691 A.

α-Olefin comonomer content is preferably from 2 to 40 mol %, more preferably from 5 to 35 mol % and particularly preferably from 10 to 25 mol %, based in each case on the entirety of ethylene and the comonomer(s).

The ethylene-α-olefin copolymers or terpolymers described are preferably random copolymers.

The copolymers or terpolymers having grafted-on anhydride groups can be subjected to incipient crosslinking as described in WO 98/02489 in order to optimize elastomeric properties.

The proportions of ethylene and of the comonomers can be determined by ¹H and ¹³C NMR spectroscopy in trichloroethane as solvent.

The anhydride-modified polymer is characterized by the following composition:
B(1) from 90.0% to 99.99% by weight, preferably from 97.0% to 99.99% by weight, particularly preferably from 98.0% to 99.7% by weight and very particularly preferably from 99.0% to 99.7% by weight, of copolymer or terpolymer,
B(2) from 0.01 to 10.0% by weight, preferably from 0.01 to 3.0% by weight, particularly preferably from 0.3 to 2.0% by weight and very particularly preferably from 0.3 to 1.0% by weight, of anhydride.

In an embodiment to which further preference is given, the main chain of component B consists of a random copolymer made of ethylene and 1-octene units.

The weight-average molar mass Mw of the anhydride-modified copolymer is from more than 50000 to 500000 g/mol, preferably from 100000 to 400000 g/mol and particularly preferably from 150000 to 350000 g/mol, determined in each case by HTGPC (high-temperature gel permeation chromatography) with ortho-dichlorobenzene as solvent against polystyrene standards.

The glass transition temperatures of the preferred products are −50° C. or lower.

Glass transition temperature is determined by differential scanning calorimetry (DSC) in accordance with the standard DIN EN 61006 (2004 version) at a heating rate of 10 K/min, T_{g} being defined as mid-point temperature (tangent method).

### Component C

The composition can comprise, as component C, one or more further additives, preferably selected from the group consisting of flame retardants (e.g. organic phosphorus or halogen compounds, in particular bisphenol-A-based oligophosphate), anti-drip agents (for example compounds from the classes of fluorinated polyolefins, the silicones, and also aramid fibres), flame retardant synergists (for example nanoscale metal oxides), smoke inhibitors (for example zinc borate), lubricants and demoulding agents (for example pentaerythritol tetrastearate), nucleating agents, antistats, conductivity additives, stabilizers (e.g. hydrolysis, heat-ageing and UV stabilizers, and also transesterification inhibitors and acid/base quenchers), flow promoters, compatibilizers, other polymeric constituents (for example polyesters or vinyl (co)polymers or functional blend components), fillers and reinforcing materials (for example carbon fibres, talc, mica, kaolin, CaCO₃) and also dyes and pigments (for example titanium dioxide or iron oxide).

In a preferred embodiment, the composition is free from flame retardants, anti-drip agents, flame retardant synergists and smoke inhibitors.

In a likewise preferred embodiment, the composition is free from fillers and reinforcing materials.

In a particularly preferred embodiment, the composition is free from flame retardants, anti-drip agents, flame retardant synergists, smoke inhibitors and fillers and reinforcing materials.

In a preferred embodiment, the composition is free from flame retardants, anti-drip agents, flame retardant synergists and smoke inhibitors.

In a likewise preferred embodiment, the composition is free from fillers and reinforcing materials.

In a particularly preferred embodiment, the composition is free from flame retardants, anti-drip agents, flame retardant synergists, smoke inhibitors and fillers and reinforcing materials.

In a preferred embodiment, the composition comprises at least one polymer additive selected from the group consisting of lubricants and demoulding agents, stabilizers, flow promoters, compatibilizers, other polymeric constituents, dyes and pigments.

In a particularly preferred embodiment, the composition comprises at least one polymer additive selected from the group consisting of lubricants and demoulding agents, stabilizers, flow promoters, compatibilizers, other polymeric constituents, dyes and pigments, and is free from other polymer additives.

In a preferred embodiment, the composition comprises at least one polymer additive selected from the group consisting of lubricants/demoulding agents and stabilizers.

In a particularly preferred embodiment, the composition comprises at least one polymer additive selected from the group consisting of lubricants/demoulding agents and stabilizers, and is free from other polymer additives.

In a preferred embodiment, the composition comprises pentaerythritol tetrastearate as demoulding agent.

In a preferred embodiment, the composition comprises as stabilizer, at least one representative selected from the group consisting of sterically hindered phenols, organic phosphites, sulfur-based co-stabilizers and organic and inorganic Bronsted acids.

In a particularly preferred embodiment, the composition comprises as stabilizer at least one representative selected from the group consisting of octadecyl 3-(3,5-di-tert-butyl-4-hydroxyphenyl)propionate and tris(2,4-di-tert-butylphenyl) phosphite.

In an especially preferred embodiment, the composition comprises as stabilizer a combination of octadecyl 3-(3,5-di-tert-butyl-4-hydroxyphenyl)propionate and tris(2,4-di-tert-butylphenyl) phosphite.

Particularly preferred compositions comprise pentaerythritol tetrastearate as demoulding agent, at least one representative selected from the group consisting of octadecyl 3-(3,5-di-tert-butyl-4-hydroxyphenyl)propionate and tris(2,4-di-tert-butylphenyl) phosphite as stabilizer, and optionally a Bronsted acid, and are free from other polymer additives.

Compositions to which preference is further given comprise pentaerythritol tetrastearate as demoulding agent, a combination of octadecyl 3-(3,5-di-tert-butyl-4-hydroxyphenyl)propionate and tris(2,4-di-tert-butylphenyl) phosphite as stabilizer, and optionally a Bronsted acid, and are free from other polymer additives.

### Production of the Moulding Materials and Mouldings

The compositions according to the invention can be used to produce thermoplastic moulding materials.

The thermoplastic moulding materials according to the invention can by way of example be produced by mixing the respective constituents in a known manner and compounding in the melt, and extruding in the melt, at temperatures which are preferably from 200° C. to 340° C., particularly preferably from 240 to 320° C. and very particularly preferably from 240° C. to 300° C., in conventional assemblies such as internal mixers, extruders and twin-shaft screw systems. For the purposes of this application, this process is generally termed compounding.

The procedure here is that at least component A is melted, all of the constituents of the composition are dispersed and/or dissolved in one another, and in a further step the resultant melt is solidified by cooling and optionally pelletized. The steps of solidification and pelletization can be carried out in any desired order.

The term moulding material therefore means the product that is obtained when the constituents of the composition are compounded in the melt and extruded in the melt.

The individual constituents can be mixed in a known manner either in succession or else simultaneously, and specifically either at about 20° C. (room temperature) or else at a higher temperature. It is therefore possible by way of example that some of the constituents are metered into the system by way of the main intake of an extruder and that the remaining constituents are introduced subsequently in the compounding process by way of an ancillary extruder.

The invention also provides a process for the production of the moulding materials of the invention.

The moulding materials of the invention can be used for the production of mouldings of any type. These can by way of example be produced by injection moulding, extrusion and blow-moulding processes. Another type of processing is the production of mouldings by thermoforming from prefabricated sheets or films.

Examples of these mouldings are films, profiles, housing parts of any type, e.g. for domestic appliances such as juice presses, coffee machines, mixers; for office equipment such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automobile sector. The compositions according to the invention are also suitable for the production of the following mouldings or moulded parts: Internal fitout parts for rail vehicles, ships, aircraft, buses and other motor vehicles, bodywork components for motor vehicles, housings of electrical equipment containing small transformers, housings for equipment for the processing and transmission of information, housings and cladding for medical equipment, massage equipment and housings therefor, toy vehicles for children, sheet-like wall elements, housings for safety equipment, thermally insulated transport containers, moulded parts for sanitation and bath equipment, protective grilles for ventilation openings and housings for garden equipment.

Further embodiments 1 to 32 of the present invention are described below:

1. Compositions for the production of thermoplastic moulding materials, where the compositions comprise the following constituents:
A) At least one polymer selected from the group consisting of aromatic polycarbonate, aromatic polyester carbonate or polyester,
B) at least one anhydride-functionalized ethylene-α-olefin copolymer or ethylene-α-olefin terpolymer,
where the average molar mass Mw of component B is from 50000 to 500000 g/mol.

2. Compositions according to embodiment 1, where the weight-average molar mass Mw of component A is from 18 000 to 35 000 g/mol.

3. Compositions according to embodiment 1, where the weight-average molar mass Mw of component A is from 20 000 to 32 000 g/mol.

4. Compositions according to embodiment 1, where the weight-average molar mass Mw of component A is from 24 000 to 31 000 g/mol.

5. Compositions according to any of the preceding embodiments, where component B has from 2 to 40 mol % of α-olefin units and from 60 to 98 mol % of ethylene units, based on the entirety of α-olefin and ethylene.

6. Compositions according to any of the preceding embodiments, where component B has from 5 to 35 mol % of α-olefin units and from 65 to 95 mol % of ethylene units, based on the entirety of α-olefin and ethylene.

7. Compositions according to any of the preceding embodiments, where component B has from 10 to 25 mol % of α-olefin units and from 75 to 90 mol % of ethylene units, based on the entirety of α-olefin and ethylene.

8. Compositions according to any of the preceding embodiments, where the anhydride in component B is selected from the group comprising maleic anhydride, phthalic anhydride, fumaric anhydride and itaconic anhydride, and also mixtures of these.

9. Compositions according to any of the preceding embodiments, where the anhydride in component B is maleic anhydride.

10. Compositions according to any of the preceding embodiments, where the anhydride content of component B is from 0.01% to 10.0% by weight.

11. Compositions according to any of the preceding embodiments, where the anhydride content of component B is from 0.01% to 3.0% by weight.

12. Compositions according to any of the preceding embodiments, where the anhydride content of component B is from 0.3% to 2.0% by weight.

13. Compositions according to any of the preceding embodiments, where the anhydride content of component B is from 0.3% to 1.0% by weight.

14. Compositions according to any of the preceding embodiments, where the α-olefin in component B is selected from the group comprising 1-propene, 1-butene, 1-isobutene, 1-pentene, 1-hexene, 1-heptene, 1-octene, 1-nonene, 1-decene, 1-undecene, 1-dodecene, 1-tridecene, 1-tetradecene, 1-octadecene, 1-nonadecene, and also mixtures of these.

15. Compositions according to any of the preceding embodiments, where component B is a maleic-anhydride-functionalized copolymer of ethylene and 1-octene.

16. Compositions according to any of the preceding embodiments, where the weight-average molar mass Mw of component B is from 100 000 to 400 000 g/mol.

17. Compositions according to any of the preceding embodiments, where the weight-average molar mass Mw of component B is from 150 000 to 350 000 g/mol.

18: Compositions according to any of the preceding embodiments, where component A consists only of aromatic polycarbonate.

19. Compositions according to any of the preceding embodiments, comprising from 0.1% to 10% by weight of component B.

20. Compositions according to any of the preceding embodiments, comprising
from 40 to 99.9% by weight of component A,
from 0.1 to 10% by weight of component B,
from 0 to 50% by weight of other polymeric constituents and/or polymer additives as component C.

21. Compositions according to any of the preceding embodiments, comprising
from 60 to 99.4% by weight of component A,
from 0.5 to 9% by weight of component B,
from 0.1 to 39.5% by weight of other polymeric constituents and/or polymer additives as component C.

22. Compositions according to any of the preceding embodiments, comprising
from 80 to 98.8% by weight of component A,
from 1 to 8% by weight of component B,
from 0.2 to 19% by weight of other polymeric constituents and/or polymer additives as component C.

23. Compositions according to any of the preceding embodiments, where component C comprises at least one stabilizer selected from the group of the phenolic antioxidants and phosphites.

24. Compositions according to any of the preceding embodiments, where component C comprises a mixture of one phenolic antioxidant and of at least one phosphite.

25. Compositions according to any of the preceding embodiments, consisting of at least 90% by weight of components A to C.

26. Compositions according to any of the preceding embodiments, consisting of components A to C.

27. Process for the production of moulding materials, comprising the steps (i), (ii) and optionally (iii), where, in a first step (i)
Compositions according to any of embodiments 1 to 26
are heated via introduction of thermal and/or mechanical energy, at least component A) is thus melted, and all of the components used are dispersed and/or dissolved in one another,
and
in a further step (ii)
the melt (ii) resulting from step (i) is solidified by cooling
and (iii) optionally pelletized,
where the steps (ii) and (iii) can be carried out in any desired order.

28. Process according to embodiment 27, where the step (i) is carried out at a temperature of from 200° C. to 320° C.

29. Process according to embodiment 27, where the step (i) is carried out at a temperature of from 240° C. to 300° C.

30. Moulding materials obtained or obtainable by a process according to any of embodiments 27 to 29.

31. Use of compositions according to any of the preceding embodiments 1 to 26 or of a moulding material according to embodiment 30 for the production of mouldings.

32. Mouldings comprising compositions according to any of embodiments 1 to 26 or a moulding material according to embodiment 30.

### EXAMPLES

### Components Used:

### Component A:

A1: Linear polycarbonate based on bisphenol A with weight-average molar mass M_{w} 28 000 g/mol determined by gel permeation chromatography in methylene chloride with polycarbonate as standard.

A2: Linear polycarbonate based on bisphenol A with weight-average molar mass M_{w} 24 000 g/mol determined by gel permeation chromatography in methylene chloride with polycarbonate as standard.

### Component B:

B1: Maleic-anhydride-functionalized ethylene-1-octene copolymer with MAH content of 0.8% by weight and with an ethylene:1-octene ratio of 87:13 mol %, and with weight-average molar mass M_{w} 200 000 g/mol (Paraloid™ EXL 3808 D, producer Dow Chemical).

B2: Maleic-anhydride-functionalized ethylene-1-octene copolymer with MAH content of 0.4% by weight and with an ethylene:1-octene ratio of 83:17 mol %, and with weight-average molar mass M_{w} 322 000 g/mol (Paraloid™ EXL 3815, producer Dow Chemical).

B3: Maleic-anhydride-functionalized ethylene-1-octene copolymer with MAH content of 1.55% by weight and with an ethylene:1-octene ratio of 67:33 mol %, and with weight-average molar mass M_{w} 166 000 g/mol (Scona™ TSPOE 1002 GBLL, producer Byk Chemie).

B4: Maleic-anhydride-functionalized ethylene-1-octene copolymer with MAH content of 0.55% by weight and with an ethylene:1-octene ratio of 70:30 mol %, and with weight-average molar mass M_{w} 285 000 g/mol (Scona™ TSPOE 1002 CMB 1-2, producer Byk Chemie).

B5 (comparison): Impact modifier with core-shell structure and with a silicone-acrylate composite rubber as core (Metablen™ 52001, producer Mitsubishi Rayon)

B6 (comparison): Impact modifier with core-shell structure and with an acrylate rubber as core (Paraloid™ EXL 2300, producer Dow Chemical)

B7 (comparison): Impact modifier with core-shell structure and with a butadiene rubber as core (Kane ACE™ M732, producer Kaneka).

B8 (comparison): Ethylene-propylene-octene-maleic anhydride copolymer with ethylene:propylene octene ratio 87:6:7 in % by weight (corresponding to 94:4:2 in mol %), CAS No. 31069-12-2, with molar mass Mw 5000 g/mol determined by GPC with polystyrene as standard and with maleic anhydride content 4.4% by weight, HiWax™ 1105 A (producer Mitsui Chemicals).

### Component C:

C1: Heat stabilizer, Irganox™ B900 (mixture of 80% Irgafos™ 168 (tris(2,4-di-tert-butylphenyl) phosphite) and 20% of Irganox™ 1076 (2,6-di-tert-butyl-4-(octadecanoxycarbonylethyl)phenol); BASF (Ludwigshafen, Germany).

C2: Demoulding agent, pentaerythritol tetrastearate

### Production and Testing of the Moulding Materials of the Invention

The components were mixed in a ZSK-25 twin-screw extruder from Werner & Pfleiderer at a melt temperature of 300° C. The mouldings were produced at a melt temperature of 300° C. and a mould temperature of 80° C. in an Arburg 270 E injection-moulding machine.

MVR is determined in accordance with ISO 1133 (2012 version) at 300° C., using 1.2 kg ram loading and a melting time of 5 minutes.

Properties used as a measure of chemicals resistance are environmental stress cracking (ESC) resistance in rapeseed oil and sun cream with light-protection factor 50 (Nivea™ SUN 50+) and (Sebamed™) hand+nail balsam at room temperature. A test specimen measuring 80 mm×10 mm×4 mm injection-moulded at melt temperature 300° C. is subjected to 2.0% external outer fibre strain by means of a clamping template and completely immersed in the liquid, and the time required for fracture failure induced by environmental stress cracking is determined. The following evaluation system is used:

| Time required for fracture failure | Evaluation |
|---|---|
| <1 day | −−− |
| from 1 to 2 days | −− |
| from 2 to 3 days | − |
| from 3 to 4 days | 0 |
| from 4 to 5 days | + |
| from 5 to 6 days | ++ |
| from 6 to 7 days | +++ |

Charpy notched impact resistance was determined at various temperatures (from 23° C. to −50° C.) in accordance with ISO 179/1eA (2010 version) on respectively ten test specimens measuring 80 mm×10 mm×4 mm. Individual notched impact resistance values≥30 kJ/m² were evaluated as tough fracture behaviour. In each case, the average value from the individual values≥30 kJ/m² and <30 kJ/m² is stated.

Vicat B/120 as a measure of heat resistance was determined in accordance with ISO 306 (2013 version) on test specimens measuring 80 mm×10 mm×4 mm with ram loading 50 N and heating rate 120° C./h.

Melt viscosities were determined in accordance with ISO 11443 (2014 version) at 280 and, respectively, 300° C., in both cases at a shear rate of 1000 s⁻¹.

TABLE 1
Compositions and properties thereof

| | | | 2 | 3 | 4 | 5 |
|---|---|---|---|---|---|---|
| Component (parts by weight) | | 1 | (comp.) | (comp.) | (comp.) | (comp.) |
| A1 | | 94.5 | 94.35 | 94.35 | 94.5 | 94.5 |
| B1 | | 5.00 | | | | |
| B5 | | | 5.00 | | | |
| B6 | | | | 5.00 | | |
| B7 | | | | | 5.00 | |
| B8 | | | | | | 5.00 |
| C1 | | 0.10 | 0.25 | 0.25 | 0.10 | 0.10 |
| C2 | | 0.40 | 0.40 | 0.40 | 0.40 | 0.40 |
| Properties | Unit | | | | | |
| Charpy notched impact | kJ/m² | 70 | 67 | 67 | 62 | 53 |
| resistance (23° C.) | | | | | | |
| Charpy notched impact | kJ/m² | 69 | 63 | 62 | 61 | 26 |
| resistance (−20° C.) | | | | | | |
| VICAT | ° C. | 142 | 140 | 140.8 | 141.3 | |
| Melt viscosity (280° C.) | Pa · s at 1000 s⁻¹ | 306 | 398 | 409 | 434 | 70 |
| Melt viscosity (300° C.) | Pa · s at 1000 s⁻¹ | 211 | 258 | 247 | 283 | 42 |
| MVR (1.2 kg - 5 min, 300° C.) | cm³/[10 min] | 9.2 | 8.3 | 8.6 | 7.8 | 21 |
| Chemicals resistance | | | | | | |
| Sun cream | Evaluation | + + + | − | − | − − − | − − − |
| Hand + nail balsam | Evaluation | + + | − | + + + | − | |
| Rapeseed oil | Evaluation | 0 | − − − | − − − | −− | |

The examples in Table 1 show that the composition according to Experiment 1 with component B1 of the invention features an improved combination of very good notched impact resistance, high heat resistance and very good melt flowability. The composition from Experiment 1 moreover has significantly improved chemicals resistance. With the core-shell impact modifiers used for comparative purposes, B5, B6 and B7, for identical usage concentrations, somewhat lower notched impact resistance values and heat resistance values are obtained, with significantly poorer flowability values and chemicals resistance values. When the ethylene-propylene-octene-maleic anhydride copolymer B8 not of the invention was used, notched impact resistance and chemicals resistance are inadequate.

TABLE 2
Compositions and properties thereof

| Raw material [parts by weight] | | 6 | 7 | 8 | 9 | 10 | 11 | 12 |
|---|---|---|---|---|---|---|---|---|
| A2 | | 99.4 | 95.6 | 91.6 | 91.35 | 95.6 | 91.6 | 91.35 |
| B1 | | | 4 | 8 | 8 | | | |
| B2 | | | | | | 4 | 8 | 8 |
| B3 | | | | | | | | |
| B4 | | | | | | | | |
| C1 | | | | | 0.25 | | | 0.25 |
| C2 | | 0.4 | 0.4 | 0.4 | 0.4 | 0.4 | 0.4 | 0.4 |
| Charpy notched impact | Temp. | | | | | | | |
| Number of tough/brittle | 23° C. | 10/0 | 10/0 | 10/0 | 10/0 | 10/0 | 10/0 | 10/0 |
| Average value of | 23° C. | 65/0 | 62/0 | 59/0 | 63/0 | 62/0 | 59/0 | 61/0 |
| tough/brittle (kJ/m²) | | | | | | | | |
| Number of tough/brittle | 10° C. | | | | | | | |
| Average value of | 10° C. | | | | | | | |
| tough/brittle (kJ/m²) | | | | | | | | |
| Number of tough/brittle | 0° C. | | 10/0 | 10/0 | | 10/0 | | |
| Average value of | 0° C. | | 34/0 | 40/0 | | 45/0 | | |
| tough/brittle (kJ/m²) | | | | | | | | |
| Number of tough/brittle | −10° C. | 0/10 | 0/10 | 4/6 | | 2/8 | 10/0 | |
| Average value of | −10° C. | 0/16 | 0/24 | 31/26 | | 32/26 | 38/0 | |
| tough/brittle (kJ/m²) | | | | | | | | |
| Number of tough/brittle | −20° C. | | 0/10 | 0/10 | 10/0 | 0/10 | 4/6 | 10/0 |
| Average value of | −20° C. | | 0/19 | 0/21 | 61/0 | 0/22 | 32/27 | 63/0 |
| tough/brittle (kJ/m²) | | | | | | | | |
| Number of tough/brittle | −30° C. | | | | 10/0 | | 0/10 | 10/0 |
| Average value of | −30° C. | | | | 32/0 | | 0/21 | 48/0 |
| tough/brittle (kJ/m²) | | | | | | | | |
| VICAT (° C.) | | 144.3 | 144.1 | 142.9 | 142.9 | 143.7 | 143 | 142.7 |
| Melt viscosity (Pa · s at 1000 | 280° C. | 321 | 271 | 242 | 228 | 246 | 231 | 240 |
| s−1) | | | | | | | | |
| Melt viscosity (Pa · s at 1000 | 300° C. | 192 | 174 | 150 | 164 | 170 | 157 | 170 |
| s−1) | | | | | | | | |
| MVR (1.2 kg - 5 min/300° C.) | | 19.7 | 18.3 | 16.5 | 19.7 | 18.2 | 17.5 | 18.6 |

| Raw material [parts by weight] | | 13 | 14 | 15 | 16 | 17 | 18 |
|---|---|---|---|---|---|---|---|
| A2 | | 95.6 | 91.6 | 91.35 | 95.6 | 91.6 | 91.35 |
| B1 | | | | | | | |
| B2 | | | | | | | |
| B3 | | 4 | 8 | 8 | | | |
| B4 | | | | | 4 | 8 | 8 |
| C1 | | | | 0.25 | | | 0.25 |
| C2 | | 0.4 | 0.4 | 0.4 | 0.4 | 0.4 | 0.4 |
| Charpy notched impact | Temp. | | | | | | |
| Number of tough/brittle | 23° C. | 10/0 | 10/0 | 10/0 | 10/0 | 10/0 | 10/0 |
| Average value of | 23° C. | 61/0 | 53/0 | 60/0 | 60/0 | 56/0 | 60/0 |
| tough/brittle (kJ/m²) | | | | | | | |
| Number of tough/brittle | 10° C. | | 10/0 | | | | |
| Average value of | 10° C. | | 37/0 | | | | |
| tough/brittle (kJ/m²) | | | | | | | |
| Number of tough/brittle | 0° C. | 10/0 | 6/4 | 10/0 | 10/0 | 10/0 | |
| Average value of | 0° C. | 34/0 | 32/29 | 53/0 | 34/0 | 40/0 | |
| tough/brittle (kJ/m²) | | | | | | | |
| Number of tough/brittle | −10° C. | 0/10 | 0/10 | 10/0 | 0/10 | 7/3 | 10/0 |
| Average value of | −10° C. | 0/23 | 0/22 | 33/0 | 0/24 | 34/27 | 43/0 |
| tough/brittle (kJ/m²) | | | | | | | |
| Number of tough/brittle | −20° C. | 0/10 | 0/10 | 0/10 | 0/10 | 0/10 | 6/4 |
| Average value of | −20° C. | 0/18 | 0/18 | 0/23 | 0/18 | 0/23 | 31/28 |
| tough/brittle (kJ/m²) | | | | | | | |
| Number of tough/brittle | −30° C. | | | | | | 0/10 |
| Average value of | −30° C. | | | | | | 0/20 |
| tough/brittle (kJ/m²) | | | | | | | |
| VICAT (° C.) | | 144.1 | 142.8 | 142.2 | 144.3 | 142.4 | 142.4 |
| Melt viscosity (Pa · s at 1000 | 280° C. | 296 | 277 | 252 | 283 | 264 | 256 |
| s−1) | | | | | | | |
| Melt viscosity (Pa · s at 1000 | 300° C. | 180 | 176 | 174 | 183 | 173 | 180 |
| s−1) | | | | | | | |
| MVR (1.2 kg - 5 min/300° C.) | | 17.5 | 15.7 | 16.8 | 17.5 | 15.7 | 16.8 |

The data in Table 2 reveal the effect of the usage concentration of component B of the invention on toughness, heat resistance and flowability. It can moreover be seen that particularly good toughness values can be achieved with 1-octene content of from 10 to 25 mol %, i.e. with the raw materials B1 and B2. Toughness can moreover be still further improved by using a stabilizer mixture of phenolic antioxidant and phosphite stabilizer.

1. A composition for the production of thermoplastic moulding materials, wherein the composition comprises the following constituents:
A) at least one polymer selected from the group consisting of aromatic polycarbonate, aromatic polyester carbonate, and polyester and
B) at least one anhydride-functionalized with ethylene-α-olefin-copolymer or ethylene-α-olefin terpolymer,
wherein a weight-average molar mass Mw of component B, determined by high-temperature gel permeation chromatography using ortho-dichlorobenzene as solvent against polystyrene standards is from 5 000 to 500 000 g/mol.

2. The composition according to claim 1, wherein component B has from 2 to 40 mol % of α-olefin units and from 60 to 98 mol % of ethylene units, based on the entirety of α-olefin and ethylene.

3. The composition according to claim 1, wherein an anhydride content of component B is from 0.01 to 3.0% by weight.

4. The composition according to claim 1, wherein component B is a maleic-anhydride-functionalized copolymer of ethylene and 1-octene.

5. The composition according to claim 1, wherein the weight-average molar mass Mw of component B is from 100 000 to 400 000 g/mol.

6. The composition according to claim 1, wherein component B has from 10 to 25 mol % of 1-octene units and from 75 to 90 mol % of ethylene units, based on the entirety of 1-octene and ethylene.

7. The composition according to claim 1, wherein the anhydride content of component B is from 0.3 to 2.0% by weight.

8. The composition according to claim 1, wherein component A consists of aromatic polycarbonate.

9. The composition according to claim 1, comprising from 0.1% to 10% by weight of component B.

10. The composition according to claim 1, comprising:
from 40 to 99.9% by weight of component A,
from 0.1 to 10% by weight of component B, and
from 0 to 50% by weight of other polymeric constituents and/or polymer additives as component C.

11. The composition according to claim 1, wherein component C comprises a mixture of at least one phenolic antioxidant and of at least one phosphite.

12. A process for the production of moulding materials, comprising the steps (i), (ii) and optionally (iii), wherein, in the first step (i)
the composition according to claim 1 is heated via introduction of thermal and/or mechanical energy, at least component A) is thus melted, and all of the components used are dispersed and/or dissolved in one another, and
in the further step (ii)
the melt resulting from step (i) is solidified by cooling, and
(iii) optionally pelletized,
wherein the steps (ii) and (iii) can be carried out in any desired order.

13. A moulding material obtained or obtainable by the process according to claim 12.

14. A process for the production of mouldings, the process comprising:
utilizing the composition according to claim 1.

15. A moulding comprising the composition according to claim 1.

16. A process for the production of mouldings, the process comprising:
utilizing the moulding material according to claim 13.

17. A moulding comprising the moulding material according to claim 13.
